(19) United States
(12) Patent Application Publication
(10) Pub. No.: US 2014/0164180 A1
(43) Pub. Date: Jun. 12, 2014

(54) NOTARY APPLICATION SERVICES KIT

(71) Applicant: MarkMaster, Inc., Tampa, FL (US)

(72) Inventor: Kevin Armand Govin, Tampa, FL (US)

(73) Assignee: MARKMASTER, INC., Tampa, FL (US)

(21) Appl. No.: 14/150,077

(22) Filed: Jan. 8, 2014

Related U.S. Application Data
(63) Continuation of application No. 12/931,276, filed on Jan. 28, 2011, now abandoned.

(51) Int. Cl. G06Q 30/06

(52) U.S. Cl. CPC G06Q 30/0613
USPC 705/26.41

(57) ABSTRACT

A notary application services kit is provided herein. In some embodiments, a notary services application kit comprises a step by step instruction sheet for using items provided in the kit; an application for notary; a check addressed to a state or county office which processes the application for notary; and a voucher for redemption of at least one of a notary bond, seal, or journal.

### CROSS-REFERENCE TO RELATED APPLICATIONS

The present application is a continuation of U.S. patent application Ser. No. 12/931,276, filed Jan. 28, 2011, the disclosure of which is incorporated herein by reference.

### FIELD OF THE INVENTION

The present application describes a kit including materials for completing the process of becoming a notary public.

### BACKGROUND OF THE INVENTION

The Notary Application Services process stems from a need for client associates to become legal notaries in a quick and easy approach. Many companies only offer partial elements needed to become a notary, such as applications, bonds or supplies. By using several different companies to fulfill the intention of becoming a notary, applicant's misuse valuable time and resources.

Therefore, further improvements in the process of being a notary public would be desirable.

### BRIEF SUMMARY OF THE INVENTION

A notary application services kit is provided herein. In some embodiments, a notary services application kit comprises a step by step instruction sheet for using items provided in the kit; an application for notary; a check addressed to a state or county office which processes the application for notary; and a voucher for redemption of at least one of a notary bond, seal, or journal.

In some embodiments, the kit includes an information sheet summarizing the items included in the kit.

In some embodiments, the kit includes a list providing locations of training course centers in the given state or county.

In some embodiments, the kit includes an application for a training course.

In some embodiments, the kit includes a check addressed to an organization that administers the training course.

In some embodiments, the kit includes an application for a notary examination.

In some embodiments, the kit includes a check addressed to an organization that administers the notary examination.

In some embodiments, the kit includes a list providing locations of examination centers in the given state or county.

In some embodiments, the kit includes an application for a background check.

In some embodiments, the kit includes a check addressed to an organization that administers the background check.

In some embodiments, the kit includes a list providing locations of background check centers in the given state or county.

### DETAILED DESCRIPTION

A kit including materials for completing the process of becoming a notary public is provided herein. The kit can be tailored on a state by state, and/or county by county basis for each individual state or county's notary requirements. The kit can simplify the process for a notary applicant. The kit includes all materials for completing the process of becoming a notary public, and can be sold to the applicant for a flat fee.

The contents of a kit can vary on a state by state basis and/or county by county basis. A kit may include one or more of the following materials.

An information sheet, which may include a list of items contained in the kit, a list of eligibility requirements for becoming a notary public, contact information for the state or county's offices, and the like. The information sheet may be tailored to reflect the contents of a kit for a particular state or county.

Step by step instructions for using the contents of the kit and for completing the process of becoming a notary public. The step by step instructions can vary on a state by state, and/or county by county basis. For example, an initial step can be receiving a kit from Mark Master, Inc. Subsequent steps can include instructions to fill out a notary application, register for an exam, complete an online training course, locate an approved center for a background check, or other steps depending on a state or county's individual requirements. A later step, and in some embodiments a final step, can be to send information indicative of passing a state or county's requirements to MarkMaster, Inc. to receive a notary bond, stamp, lock, journal, and/or completely confidential cover.

A notary application, which can vary on a state by state, and/or county by county basis. In some embodiments, a notary application may simply require the applicant to fill in series of information, such as name, address, date of birth, and answer a series of questions, such as questions related to previous work experience or criminal background. In other embodiments, a notary application may require the applicant to first complete a course and/or exam, and then indicate on the application that the course was completed and/or the exam was passed.

An application for a background check and/or identification services, which can vary on a state by state, and/or county by county basis. For example, a background check or identification can include fingerprinting, or the like. One exemplary service for background checks and/or identification services is Live Scan. The kit may include a list providing locations of service centers for background checks and/or identification services throughout a state or county.

An application for a training course, which can vary on a state by state, and/or county by county basis. For example, a training course may be administered online or in person. For an in-person training course, the kit may include a list providing locations of training centers throughout a state or county. For example, training centers may include community colleges, private training organizations, or the like. In some embodiments, the kit can include forms related to certifying that a course was taken. One exemplary form can be a declaration which the notary applicant will sign upon completion of an education course.

An application for a notary examination, which can vary on a state by state, and/or county by county basis. For example, some states may not require an examination, while others may require it. The examination may be administered online or in person. For example, for in person examinations, the kit may include one or more of a list providing locations of testing centers, such as a community college, private testing organizations or the like, and a schedule of times when an examination is being offered.

One or more checks addressed to intended recipients for steps of the process that require payment. The number of checks included in the kit may vary on a state by state and/or county by county basis. For example, one or more checks may be individually addressed to a given state entity and/or private organization to pay for a notary application processing fee, a recording fee, an examination fee, a training course fee, a background check and/or fingerprinting fee. The kit can include one or more lists providing locations of a county clerk's office, recording office, and/or prothonotory office, where payments can be sent or the applicant can appear in person to pay fees.

A voucher, which can vary state by state and/or county by county. The voucher may be for one or more of a notary bond, stamp, lock, journal, completely confidential cover, embossing notary seal, embosser inker, thumb printer, self-inking notary stamp, notary jurant stamp, and/or other notary materials. Upon completing the requirements to become a notary, the notary applicant can provide proof of certification as a notary, and the voucher can be redeemed by MarkMaster, Inc. for one or more of the above-mentioned notary materials.

Additional documents can be included in the kit, such as jurant forms, acknowledgements forms, notary errors and omission materials, notary record book, notary guidebook, notary handbook, and the like. The additional materials can vary on a state by state and/or county by county basis.

The present kit is part of an all-inclusive service for employers and individual applicants to become a notary. The flat fee for the kit also helps to simplify the notary application process.

One exemplary notary application process using the present invention is described below for the state of California. Shortly after the notary applicant places the order, the present kit (notary packet) will be delivered via a trackable process. The packet may include instructions, forms, addresses for testing locations (if necessary), applications, checks, bonds and a voucher for the required notary supplies. The instructions should preferably be followed in sequential order for the process to work best.

California requires a notary applicant to take a training course. Therefore, the notary applicant can use a list of training course locations provided in the kit to find a training center where the notary applicant can take the training course. The kit can further include an application for the training course, and a check addressed to the training course organization.

Once the notary applicant has completed the training course, the notary applicant can register for a notary exam. The kit provides a notary application, which, in California, presently requires proof that the training course was completed, and a photograph. The kit further provides a check for the notary application fee.

Once the notary applicant has passed the notary exam for the state of California, the state further requires a background check, such as through Live Scan or another background check organization. The kit provides an application for a background check, a list of locations where the background check can be performed, and a check addressed to an organization which performs the background check. The notary applicant can select a location from the list provided in the kit, and go to the location to complete the background check.

After the notary applicant has passed the background check, the applicant will receive a notary packet from the state of California. The notary applicant can complete the materials in the packet and return the materials to MarkMaster, Inc.

Shortly thereafter, a bond will be issued to the notary applicant. The notary applicant, upon receiving the bond, can go to a state office, such as a county clerk's office, a prothonotary office, or the like, where the state office can be selected from a list providing the locations of state offices provided in the kit. The notary applicant will also take with him, a commission certificate received in the packet from the state, and further filing forms, oath forms, and a check addressed to the state office, which are provided in the kit.

The notary applicant can further return a notary supply voucher provided in the kit and including a copy of the commission certificate to MarkMaster, Inc. A personal notary stamp or seal would then be sent to the notary applicant along with a notary journal. The applicant is then officially considered a notary public.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A notary services kit, comprising:
a step by step instruction sheet for using items provided in the kit;
an application for notary;
a check addressed to a state or county office which processes the application for notary; and
a voucher for redemption of at least one of a notary bond, seal, or journal.

2. The kit of claim 1, further comprising:
a check addressed to an organization that administers a training course.

3. The kit of claim 1, further comprising:
an application for a notary examination.

4. The kit of claim 3, further comprising:
a check addressed to an organization that administers the notary examination.

5. The kit of claim 1, further comprising:
an application for a background check.

6. The kit of claim 5, further comprising:
a check addressed to an organization that administers the background check.
